(19) United States
(12) Patent Application Publication
(10) Pub. No.: US 2010/0211633 A1
(43) Pub. Date: Aug. 19, 2010

(54) Method for Granting Authorization to Use a Function in an Industrial Automation System Comprising a Plurality of Networked Control Units, and Industrial Automation System

(75) Inventors: Sabine Dingfelder, Bubenreuth (DE); Dieter Schneider, Wõrth (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/707,753

(22) Filed: Feb. 18, 2010

(30) Foreign Application Priority Data
Feb. 19, 2009 (EP) EP09002345

(51) Int. Cl. G06F 15/16

(52) U.S. Cl. 709/203

(57) ABSTRACT

In order to grant authorization to use a function in an industrial automation system comprising a plurality of networked control units, functions of the automation system are provided by services of the control units. Service interfaces are separated inside a client/service architecture, on the service side, into interfaces which provide either security-critical functions or functions which are not critical to security. The separated service-side interfaces are hidden from client applications by a client-side interface in which the service-side interfaces are recorded. Functions provided by services can be called solely via the client-side interface.

### BACKGROUND OF THE INVENTION

Due to the ever-increasing importance of information technology for automation systems, methods for protecting networked system components, such as monitoring, control and regulating devices, sensors and actuators, from unauthorized access are becoming increasingly important. In comparison with other fields in which information technology is used, data integrity in automation technology is particularly important. Here, it is important to ensure that complete and unaltered data are present, in particular when recording, evaluating and transmitting measurement and control data. Intentional changes, unintentional changes or changes caused by a technical fault should be avoided. Particular requirements in automation technology for security-related methods also result from message traffic with a relatively large number of relatively short messages. In addition, the real-time capability of an automation system and its system components must be taken into account.

Particularly in automation systems based on service-oriented architectures, very different security and access guidelines for the provided services often have to be applied. Here, it is necessary to apply security and access guidelines not only to users but also to services which resort to other services. Services or functions which are not intended to be accessed by all users or services in an automation system require access control methods. Security and access guidelines defined for access control methods may themselves be individually very different in the case of services or functions that are logically closely coupled. In the case of previous solutions, this requirement occasionally gives rise to a large amount of administrative effort for maintaining security-relevant and access-relevant settings.

### SUMMARY OF THE INVENTION

It is therefore an object of the present invention to provide an efficient method for granting access authorizations in an industrial automation system and of specifying a suitable technical implementation of the method.

This and other objects are and advantages are achieved in accordance the invention by a method in which functions of an automation system are provided by services of networked control units of the automation system. In preferred embodiments, the control units are programmable. In other embodiments, the automation system comprises a production, process or building automation system. In accordance with the disclosed embodiments of the invention, service interfaces are separated inside a client/service architecture, on the service side, into interfaces which provide either security-critical functions or functions which are not critical to security. The separated service-side interfaces are hidden from client applications by a client-side interface in which the service-side interfaces are recorded. Functions provided by services can be called, in particular by client applications, solely via the client-side interface. The disclosed embodiments of the method in accordance with the invention advantageously eliminate the need for a complicated definition of security and access guidelines on the client side to protect security-critical services or functions from unauthorized access.

In accordance with an embodiment, a complete application interface is provided by the client-side interface. As a result, it becomes possible to hide the separation of the service-side interfaces according to security-critical functions, on the applications in a particularly simple and effective manner. In addition, finer differentiation of service-side interfaces to be separated is also possible. For example, service interfaces can be separated, on the service side, into interfaces which provide security-critical write functions, security-critical read functions, write functions which are not critical to security or read functions which are not critical to security.

A separate interface which provides security-critical functions is preferably provided on the service side only when at least one service component requires access to security-critical functions on the client side. As a result, it becomes possible to further reduce the effort needed to implement access control mechanisms.

In accordance with the preferred embodiments, services of the automation system are provided inside a service-oriented architecture by the control units. Service-oriented architectures (SOA) seek to structure services in complex organizational units and make them available to a multiplicity of users. Here, for example, existing components of a data processing system, such as programs, databases, servers or web sites, are coordinated such that acts provided by the components are combined to form services and are made available to authorized users. Service-oriented architectures enable application integration by hiding the complexity of individual subcomponents of a data processing system behind standardized interfaces. This results in particularly reliable and flexible provision of control information for a computer-based object in an automation system.

The automation system in accordance with the contemplated embodiments of the invention comprises a plurality of control units which are connected to each other through a communication network and are intended to provide functions of the automation system as services. The automation system also comprises a computer unit for providing a client application. A control unit is also included for providing a service which is used by the client application and the service, the interfaces of which are separated inside a client/service architecture, on the service side, into interfaces which provide either security-critical functions or functions which are not critical to security. Here, the separated service-side interfaces are hidden from client applications by a client-side interface in which the service-side interfaces are recorded. Functions provided by services can be called solely over the client-side interface.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below in an exemplary embodiment using the drawing, in which:

FIG. 1 shows a diagrammatic illustration of an automation system having a plurality of control units which are connected to one another through a communication network;

FIG. 2 shows a detailed illustration of client-side and service-side interfaces inside the automation system illustrated in FIG. 1; and

FIG. 3 is a flow chart illustrating a method in accordance with an embodiment of the invention.

### DETAILED DESCRIPTION OF THE PRESENTLY PREFERRED EMBODIMENTS

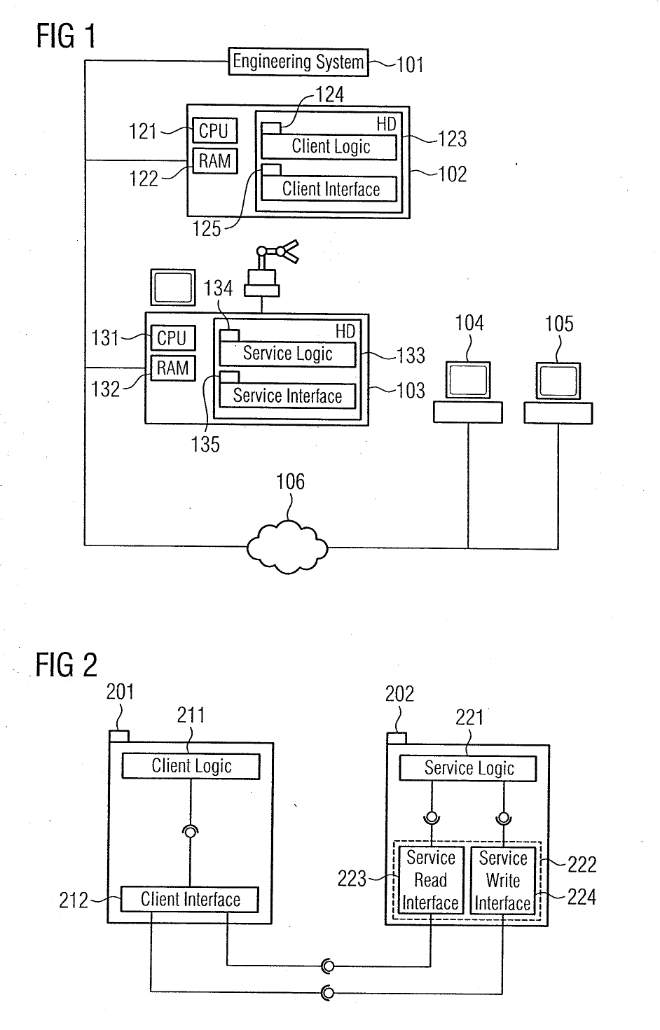

The industrial automation system illustrated in FIG. 1 comprises an engineering system 101, a client computer unit 102 and a plurality of programmable control units 103-105 which are connected to each other as network nodes by a communication network 106. The control units 103-105 provide functions of the automation system as local services which are configured and activated by configuration data.

The engineering system 101 is used to configure, maintain, start up and document the automation system and provides configuration data. The configuration data include information for assigning services to control units 103-105 and to dependencies between services.

The client computer unit 102 and the control units 103-105 each comprise at least a processor 121, 131, a main memory 122, 132 and a hard disk 123, 133 for the non-volatile storage of program code, application data and user data. The hard disk 123 of the client computer unit 102 stores program code 124 for providing a client application and program code 125 for implementing a client application programming interface. The hard disk 133 of a control unit 103 stores program code 134 for providing a local service and program code 135 for implementing a service-side service interface for the local service. In the present exemplary embodiment, the local service is used, for example, to drive metrological or actuating peripherals such as sensors or robots. The program code 124, 125, 134, 135 stored on the hard disks 123, 133 can be loaded into the main memory 122, 132 of the client computer unit 102 and the control unit 103 and can be executed by the respective processor 121, 131 to provide the above functions.

According to the detailed illustration of client-side and service-side interfaces in FIG. 2, a service interface 222 of the service 202 provided by the control unit 103 has been separated into an interface for security-critical functions 224, on the one hand, and into an interface for functions 223 which are not critical to safety. This is used to reduce the administrative effort needed to grant rights to access logically coupled functions of a service. In the present exemplary embodiment, the separated interfaces 223, 224 constitute the only possibility for accessing the service component 221 which logically implements the service 202 provided by the control unit 103.

Subdivision according to security-critical functions and functions which are not critical to security can be performed, for example, using an assessment of whether high protection requirements, such as write access operations, or low protection requirements, such as pure read access operations, need to be met in each case. Over and above subdivision according to security-critical functions and functions which are not critical to security, finer differentiation according to further protection classifications is also possible and is covered by the intended use of the contemplated embodiments of the invention.

The separation of the service-side interfaces 223, 224 is hidden, on the part of the client application 201 provided by the computer unit 102, from a service component 211 which logically implements the client application 201 by an interface 212 in which the service-side interfaces 223, 224 are recorded. In the present exemplary embodiment, functions provided by the service 202 can be called by the client application 201 solely through the client-side interface 212. For this purpose, the client-side interface 212 provides a complete application programming interface for the service component 211 which logically implements the client application 201. As a result, it becomes possible for the client application 201 to use all functions provided by the service 202 via a standard interface.

If security-critical functions of a service are not intended to be provided, the corresponding service-side interface is not provided at all. Security-critical functions provided by the service therefore need not be separately protected on the service side.

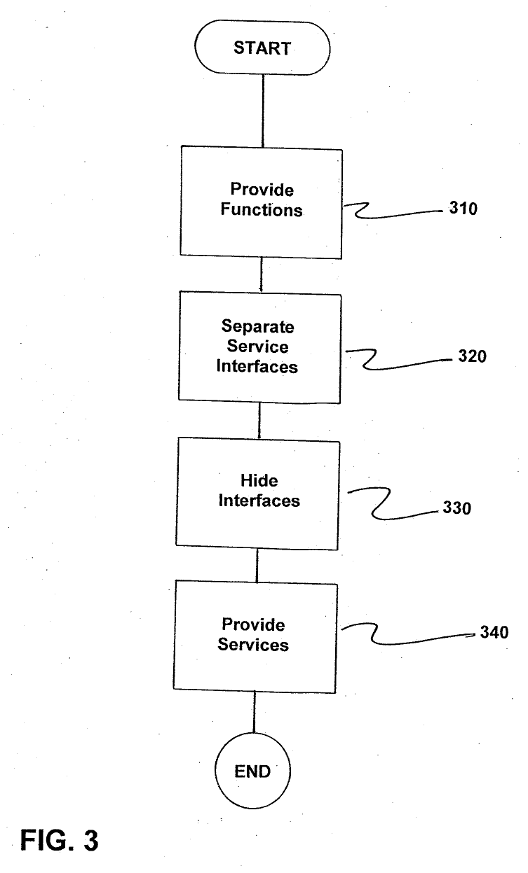

FIG. 3 is a flowchart illustrating the method for granting authorization to use a function in an industrial automation system comprising a plurality of networked control units in accordance with the invention. The method comprises providing functions of the industrial automation system by services of the plurality of networked control units, as indicated in step 310. Service-side interfaces inside a client/service architecture are separated into interfaces which provide either security-critical functions or functions which are not critical to security, as indicated in step 320. Next, the separated service-side interfaces are hidden from client applications by a client-side interface in which the service-side interfaces are recorded, as indicated in step 330. The functions are then provided by the services of the plurality of networked control units, where the function can be called solely over the client-side interface, as indicated in step 340.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for granting authorization to use a function in an industrial automation system comprising a plurality of networked control units, the method comprising:
providing functions of the industrial automation system by services of each of said plural networked control units;
separating service-side interfaces inside a client/service architecture into interfaces which provide security-critical functions and interfaces which provide functions that are not critical to security; and
hiding the separated service-side interfaces from client applications by a client-side interface in which the service-side interfaces are recorded;
wherein the functions provided by the services of each of said plural networked control units are callable solely over the client-side interface.

2. The method as claimed in claim 1, wherein the functions provided by the services of each of said plural networked control units are functions of the client applications.

3. The method as claimed in claim 1, wherein a complete application interface is provided by the client-side interface.

4. The method as claimed in claim 2, wherein a complete application interface is provided by the client-side interface.

5. The method as claimed in claim 1, wherein said separating of the service-side interfaces inside the client/service architecture includes separating the service-side interface into interfaces which provide security-critical write functions, security-critical read functions, write functions which are not critical to security and read functions which are not critical to security.

6. The method as claimed in claim 2, said separating of the service-side interfaces inside the client/service architecture includes separating the service-side interface into interfaces which provide security-critical write functions, security-critical read functions, write functions which are not critical to security and read functions which are not critical to security.

7. The method as claimed in claim 3, wherein said separating of the service-side interfaces inside the client/service architecture includes separating the service-side interface into interfaces which provide security-critical write functions, security-critical read functions, write functions which are not critical to security and read functions which are not critical to security.

8. The method as claimed in claim 1, further comprising:
providing a separate interface which provides the security-critical functions on the service side only when at least one service component requires access to the security-critical functions on the client side.

9. The method as claimed in claim 1, wherein services of the automation system are provided inside a service-oriented architecture by each of said plural networked control units.

10. The method as claimed in claim 1, wherein the automation system comprises one of a production, process and building automation system.

11. The method as claimed in claim 1, wherein the control units are programmable.

12. An industrial automation system comprising:
a plurality of control units which are connected to each through a communication network and are configured to provide functions of the automation system as services;
a computer unit configured to provide a client application; and
a control unit configured to provide a service which is used by the client application and the service;
wherein interfaces of the services provided by the control unit being separated inside a client/service architecture, on a service-side, into interfaces which provide one of security-critical functions and functions which are not critical to security, the separated service-side interfaces being hidden from client applications by a client-side interface in which the service-side interfaces are recorded; and
wherein functions provided by the services being callable solely over the client-side interface.
